(19) United States
(12) Patent Application Publication
(10) Pub. No.: US 2016/0196056 A1
(43) Pub. Date: Jul. 7, 2016

(54) PRINT ARTICLE WITH MULTI-TOUCH FUNCTION AND INTERACTIVE METHOD THEREOF

(71) Applicant: GENERALPLUS TECHNOLOGY INC., HSINCHU CITY (TW)

(72) Inventor: CHIH-YUAN YANG, JHUBEI CITY (TW)

(21) Appl. No.: 14/988,452

(22) Filed: Jan. 5, 2016

Related U.S. Application Data
(60) Provisional application No. 62/099,785, filed on Jan. 5, 2015.

(51) Int. Cl. G06F 3/0488; G06F 3/0483; G06F 3/041

(52) U.S. Cl. CPC G06F 3/04883; G06F 3/0414; G06F 3/0483; G06F 3/04886; G06F 3/0416; G06F 2203/04808; G06F 2203/04104

(57) ABSTRACT

A print article with a multi-touch function comprises a specific page, a touch sensor, a look-up table and an output circuit. The specific page has at least one virtual object. The look-up table stores a position of the virtual object and corresponding specific output data generated when the virtual object is touched. When the print article with the multi-touch function is turned to the specific page, the touch sensor detects a touch event on the specific page, and the touch event is directed to a gesture of the virtual object on the specific page, the look-up table outputs the corresponding specific output data to the output circuit according to the gesture and the virtual object.

### BACKGROUND OF THE INVENTION

1. Field of the Invention

The invention relates to a print article with an electronic function, and more particularly to a print article with a multi-touch function and an interactive method thereof.

2. Related Art

With the improvement of living standards, more and more parents start to pay attention to children's education, and also start to carefully consider the education of the preschooler. Under this background, more and more electronic puzzle products for preschoolers have been available in the markets. However, most of these products are consumer electronics products, and will cause damages to the children's body, mental and spirit after they are used for a long time. In addition, the children's reading abilities are deteriorated. Thus, the physical books are still the main tools for the early childhood education.

In order to enhance the interest of the children's book and the toy attribute and thus to enhance the children's interest on the books, an electronic children's book has been available in the market. The electronic children's book has interactive functions. For example, a button is built on the page or the contents of the page of the children's book can be automatically read. Furthermore, in order to enhance the interactivity between the children's book and the children, buttons and speakers may be built on the page. When the child presses down the hidden button inside the specific pattern on the page, the speaker outputs the voice or sound corresponding to the pattern.

However, when the pressing position is incorrect, the hidden button often cannot be triggered to cause the output of the event.

### SUMMARY OF THE INVENTION

An object of the invention is to provide a print article with a multi-touch function and an interactive method thereof to enhance the interaction between a user and a book by way of multi-touch.

In view of this, the invention provides a print article with a multi-touch function. The print article comprises a specific page, a touch sensor, a look-up table and an output circuit. The specific page has at least one specific virtual object. The look-up table coupled to the touch sensor stores a position of the specific virtual object and corresponding specific output data generated after the specific virtual object is touched. The output circuit coupled to the look-up table receives the output data. When the print article with the multi-touch function is turned to the specific page, the touch sensor detects a touch event on the specific page and the touch event is directed to a gesture of the virtual object on the specific page, the look-up table outputs the corresponding specific output data to the output circuit according to the gesture and the specific virtual object.

In the print article with a multi-touch function according to a preferred embodiment of the present invention, when the print article with the multi-touch function is turned to the specific page, and the touch sensor detects the touch event on the specific page, the look-up table outputs the corresponding specific output data to the output circuit according to the gesture, touch event data, the specific virtual object and the specific page, wherein the look-up table further stores corresponding relationships between the specific page and the gesture, the touch event data and the output data. Wherein the touch event data is selected from the group consisting of a touch position, a touch speed, a signal-to-noise ratio of a touch point, a touch pressure surface area and a touch track.

In the print article with a multi-touch function according to a preferred embodiment of the present invention, the touch sensor comprises a sensing plane for sensing touched coordinates, wherein when the touch event occurs, the touch sensor detects the touched coordinates and the signal-to-noise ratios thereof within every predetermined period of time, and the specific output data corresponding to the gesture and the touch event data is found by looking up the look-up table. In a preferred embodiment of the present invention, the print article further comprises a control circuit, for recording the touched coordinates and the signal-to-noise ratios thereof within every predetermined period of time, and calculating the touch event data.

In the print article with a multi-touch function according to a preferred embodiment of the present invention, the print article further comprises a plurality of pages and a page-turning detecting circuit. The pages comprises a first sensing page and a second sensing page and the specific page, wherein the touch sensor is disposed on the first sensing page. The page-turning detecting circuit is disposed on the second sensing page, and for detecting a current page of the print article. when the page-turning detecting circuit detects that the print article is turned to the specific page, the touch sensor detects that the touch event is present on the specific page, and the touch event is directed to the gesture of the virtual object on the specific page, the look-up table outputs the corresponding specific output data to the output circuit according to the gesture, the specific virtual object and the specific page.

In the print article with a multi-touch function according to a preferred embodiment of the present invention, the first sensing page and the second sensing page are covers of the print article. In a further embodiment of the present invention, the specific page comprises a first virtual object, a second virtual object and a third virtual object, wherein the gesture comprises sliding to the first virtual object after the second virtual object and the third virtual object are touched concurrently.

The present invention further provides a interactive method, adapted for a print article with a multi-touch function, wherein the print article comprises a specific page, a touch sensor and an output circuit, wherein the specific page has at least one specific virtual object, wherein the interactive method comprises: providing a look-up table, wherein the look-up table stores the a position of the specific virtual object and corresponding specific output data generated after the specific virtual object is touched; determining whether a touch event occurs; recording a touch point and its gesture when the touch event occurs; looking up the look-up table according to the touch point and its gesture to find a corresponding specific output data; and output the corresponding specific output data to the output circuit.

The present invention further provides a print article with a multi-touch function, the print article comprises a specific page, a conductor object, a touch sensor, a look-up table and an output circuit. The specific page is disposed on an outer profile of at least one virtual object. The conductor object has a shape corresponding to the outer profile of the virtual object. The look-up table is coupled to the touch sensor, wherein the look-up table stores a position of the virtual object and corresponding specific output data generated after the virtual object is touched. The output circuit is coupled to the look-up table and receives the output data. When the print article is turned to the specific page, and the touch sensor detects a touch event on the specific page, and the touch event is triggered by the conductor object, the look-up table outputs the corresponding specific output data to the output circuit according to the shape and the position of the conductor object and the virtual object.

The spirit of the invention is to utilize the touch sensor with the high signal-to-noise ratio to achieve the determination of the touch behaviors of the user's gesture, force, speed and the like, and thus to respond with the interactive reaction corresponding to the corresponding behavior. Thus, the independent conventional click-event reaction is no longer present on the same coordinate, while the interactive behaviors with the richer behavior modes are present. Thus, more interactive applications are provided on the print article with the multi-touch function. For example, the conceptions including the printed electronic pet and the like may also have their values in these applications.

Further scope of the applicability of the present invention will become apparent from the detailed description given hereinafter. However, it should be understood that the detailed description and specific examples, while indicating preferred embodiments of the present invention, are given by way of illustration only, since various changes and modifications within the spirit and scope of the present invention will become apparent to those skilled in the art from this detailed description.

### BRIEF DESCRIPTION OF THE DRAWINGS

FIG. 1A is a schematic view showing a print article with a multi-touch function according to a preferred embodiment of the invention.

FIG. 1B is a system circuit diagram showing the print article with the multi-touch function according to the preferred embodiment of the invention.

FIGS. 2A to 2C are exploded views showing operations when a conductor touches an e-book.

FIGS. 3A to 3C are schematic views showing positions and sensing values of a touch sensor 102 according to the embodiment of the invention.

FIG. 4 is a schematic view showing the relationship between the signal-to-noise ration SNR and the time in the touch process.

FIG. 5 is a schematic view showing changes of the position and the sensing value when a dragging gesture is executed.

FIG. 6 is a schematic view showing a specific page according to another embodiment of the invention.

FIG. 7 is a schematic view showing the hand gesture recognition according to an embodiment of the invention.

FIG. 8 is a system circuit diagram showing a print article with a multi-touch function according to a preferred embodiment of the invention.

FIG. 9 is a schematic view showing a specific page according to another embodiment of the invention.

FIG. 10 is a flowchart showing a interactive method for the print article with the multi-touch function according to an preferred embodiment of the present invention.

### DETAILED DESCRIPTION OF THE INVENTION

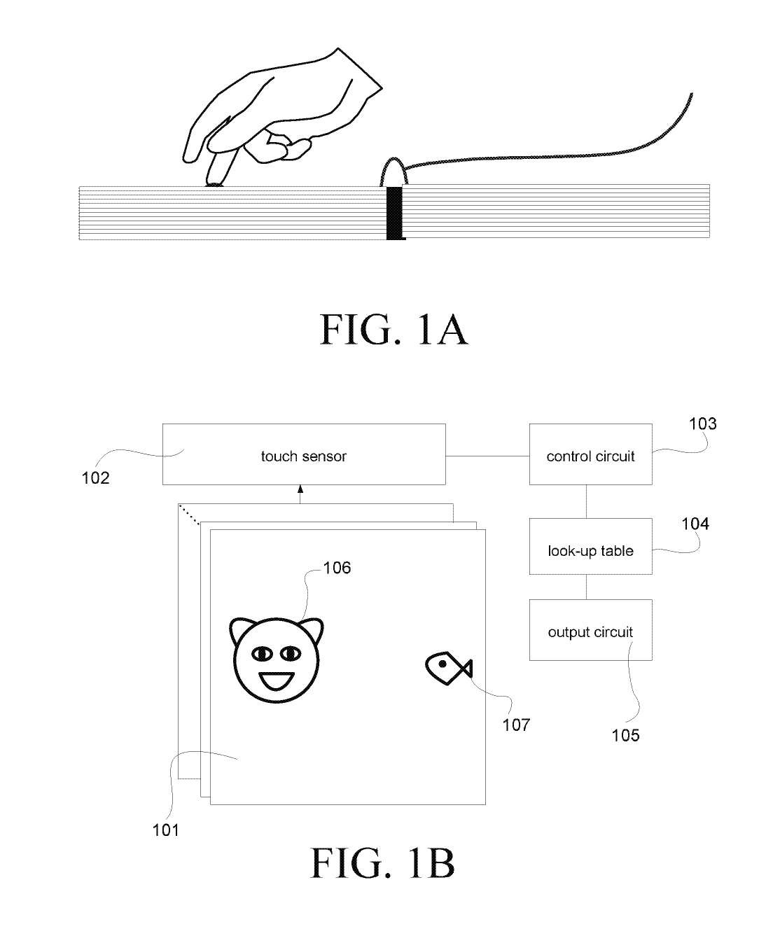

FIG. 1A is a schematic view showing a print article with a multi-touch function according to a preferred embodiment of the invention. Referring to FIG. 1A, the print article with the multi-touch function is an e-book having physical pages each made of an ordinary sheet or a cardboard, for example. The e-book having pages 101 can sense touch operations and generate corresponding interactive behaviors. FIG. 1B is a system circuit diagram showing the print article with the multi-touch function according to the preferred embodiment of the invention. Referring to FIG. 1B, the e-book has the pages 101, a touch sensor 102, a control circuit 103, a look-up table 104 and an output circuit 105. A specific page of the pages 101 has a specific virtual object. The look-up table 104 stores a position of the virtual object on the specific page, and specific output data corresponding to different gestures. The touch sensor 102 detects a touch position and a high signal-to-noise ratio. The control circuit 103 calculates the touch gesture according to the data detected by the touch sensor 102, wherein the gesture comprises, for example, a single click, a double click, a drag or the like. Referring to the example of FIG. 1B, the e-book is printed with two specific virtual objects (depicted as a kitty 106 and a fish 107), and the output circuit 105 is a speaker device.

In this example, when the user's gesture is to slide the fish 107 to the kitty 106, the touch sensor 102 detects a touch event on the specific page, and detects the touch event. The control unit records the touch points of the touch event, and calculates the touch event as corresponding to a dragging gesture with a dragging track moved from the position of the fish 107 to the position of the kitty 106. The look-up table drives the output circuit 105 to output the corresponding specific output data, such as the sound effect of eating, according to the dragging gesture and the positions of the specific virtual objects (kitty and fish).

In addition, the touch sensor 102 of this embodiment is a sensor with a high signal-to-noise ratio (SNR), can sense the capacitance levels corresponding to different force exerting areas or different forces when the conductor is touching, and can output the corresponding digital data. Meanwhile, the touch sensor 102 of the invention has the very high SNR. So, when the print article is thicker and the electric field cannot easily transmit through the print article, the touch sensor 102 of this embodiment may also sense the touch force. In other words, the invention can make the touch become more sensitive without using the page material (e.g., glass), which is very thin.

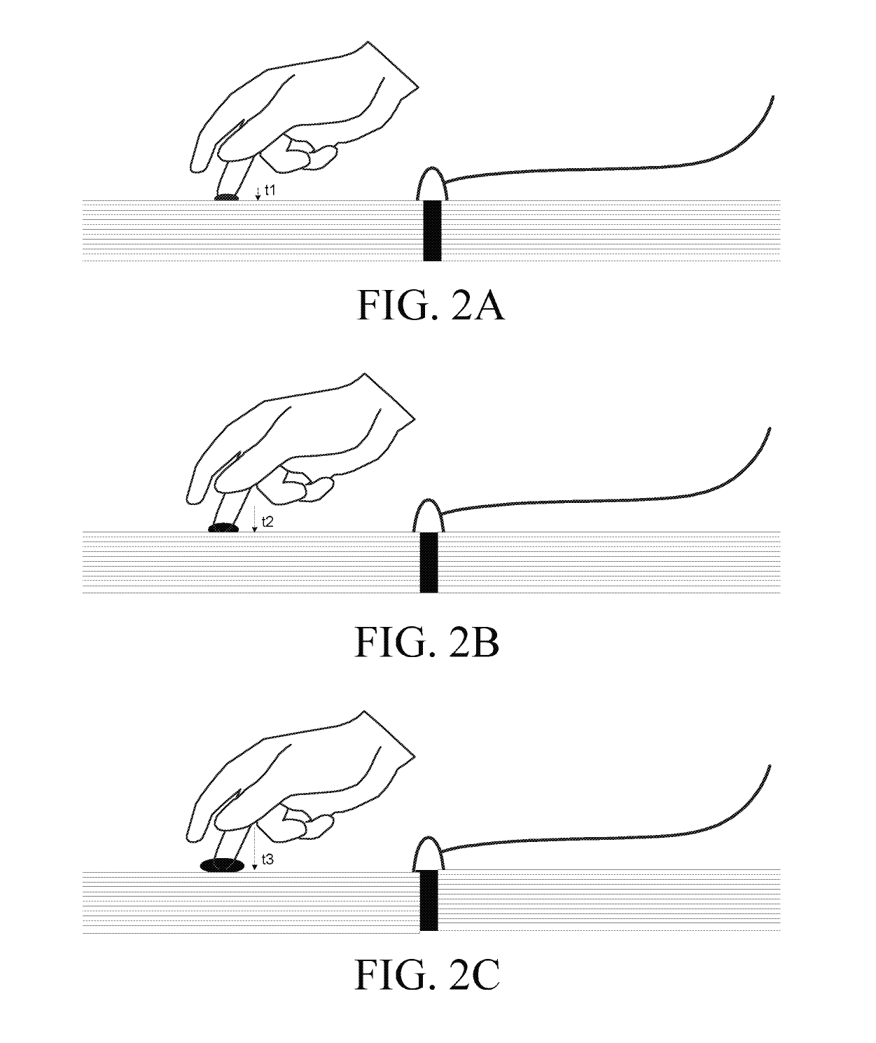

FIGS. 2A to 2C are exploded views showing operations when a conductor touches an e-book. Referring to FIGS. 2A to 2C of this embodiment, the conductor is a user's finger in order to facilitate the following description, wherein the user's finger touches the e-book from a time period t1 to a time period t3 in order. In the time period t1, the finger starts to slightly touch the e-book. From the time period t2 to the time period t3, the user also sequentially increases the touch force.

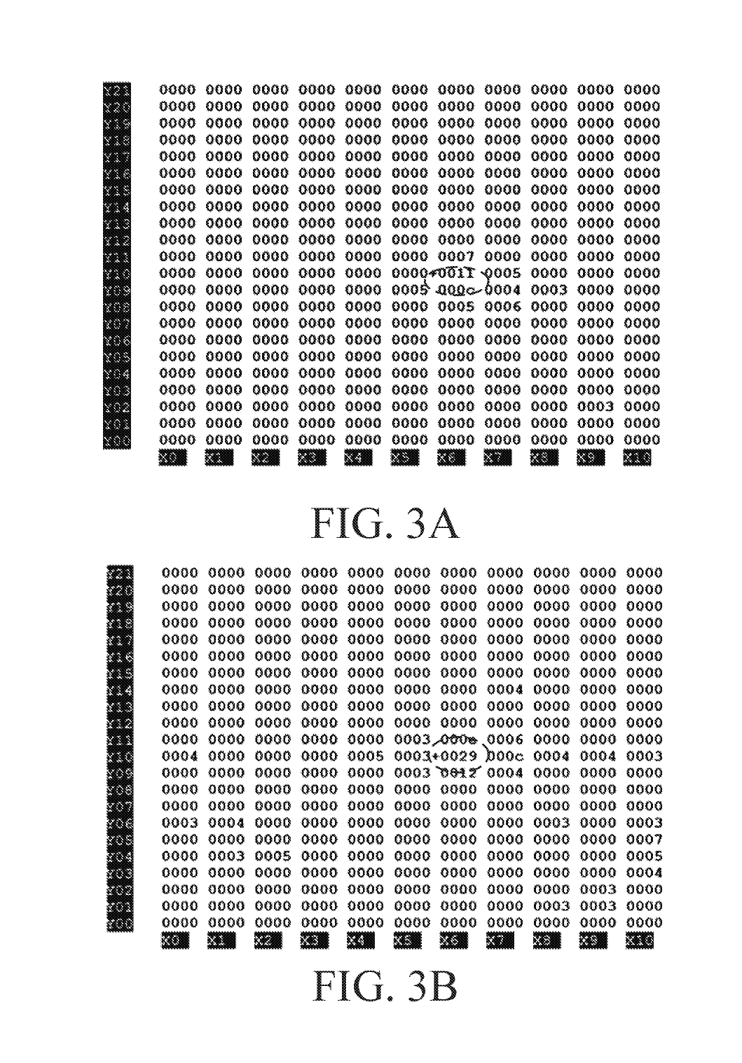

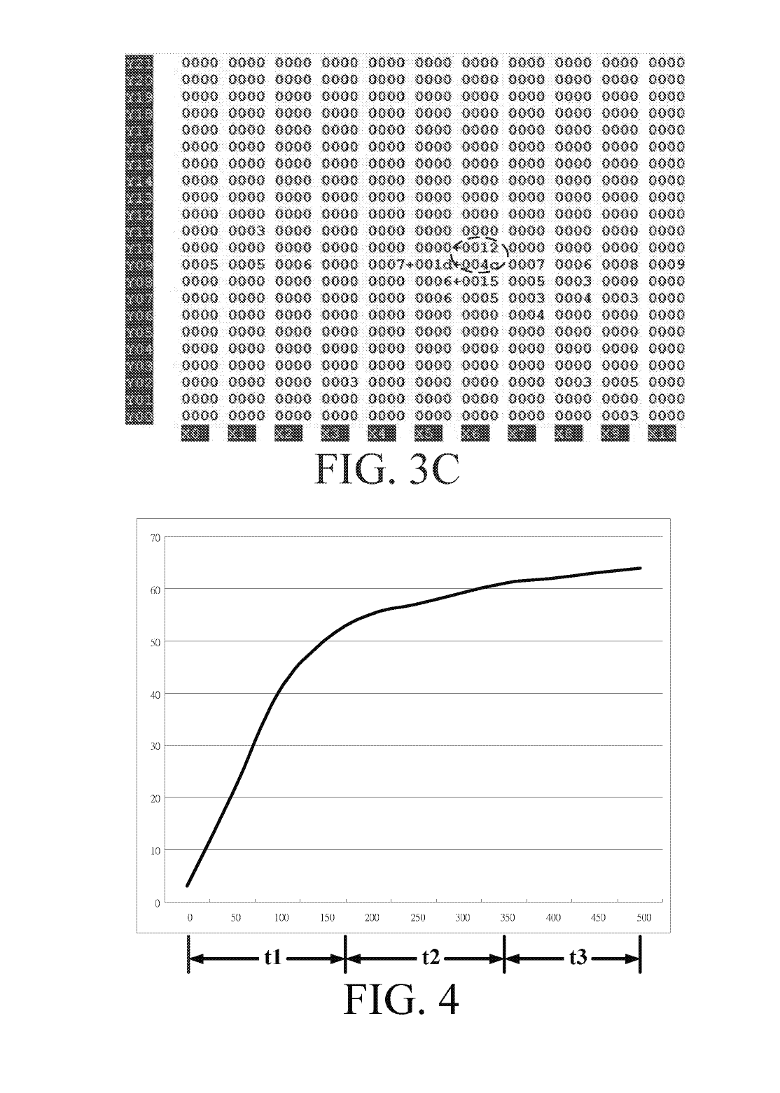

For example, the touch sensor 102 of this embodiment has a sensing plane, and the sensing values are listed in FIGS. 3A to 3C, and correspond to the touch time period t1 to the touch time period t3, respectively. FIGS. 3A to 3C are schematic views showing positions and sensing values of the touch sensor 102 according to the embodiment of the invention. For example, FIG. 3A is the schematic view of the sensing plane in the time period t1, FIG. 3B is the schematic view of the sensing plane in the time period t2, and FIG. 3C is the schematic view of the sensing plane in the time period t3. Referring first to FIG. 3A, when the user's finger starts to contact the specific page, the touch sensor 102 senses a digital signal at the contact position. In this embodiment, the digital data with a signal-to-noise ratio of “0011” is detected at the position X6Y10, for example. In the time period t2, as shown in FIG. 3B, the digital value sensed by the touch sensor 102 is increased to “0029” due to the increase of the user's touch force. In addition, digital signals are also detected at positions around the position X6Y10. Next, the digital value sensed by the touch sensor 102 is continuously increased to “004C” in the time period t3, as shown in FIG. 3C. In addition, the digital signals at the positions around the position X6Y10 are also similarly increased.

According to the above-mentioned description, it is obtained that when the user's force is gradually increased with the elapse of time, the force exerting area of the finger is also enlarged therewith. At this time, the fitness between the pages of the e-book is increased, the induced electric field is increased, and the signal-to-noise ratio detected by the touch sensor 102 is increased more significantly. FIG. 4 is a schematic view showing the relationship between the signal-to-noise ration SNR and the time in the touch process. Referring to FIG. 4, the abscissa represents the time, and the ordinate represents the signal-to-noise ratio. As shown in FIG. 4, it is obtained that the signal-to-noise ratio is significantly increased with the elapse of time in the touch process. In addition, when the user touches the e-book, the finger's touch area on the book is rapidly spread in the constant time period. That is, the touch behavior in the short time period causes the electric field energy to be absorbed significantly. The touch sensor 102 and the control circuit 103 according to the embodiment of the invention obtain the user's pressure behavior according to the above-mentioned phenomenon.

In this embodiment, the control circuit records the change of the signal-to-noise ratio with the elapse of time, as well as the touch area, and obtains the user's touch speed and force after calculation is executed to judge the user's touch emotion. The look-up table 104 further stores the touch area, the touch force and the corresponding relationship between the speed and the output data. In addition, this embodiment may also work in conjunction with the gesture detection as well as the detection of the force and the speed to judge the gesture's force representation, so that the e-book has the more diversified interactive functions.

For example, when the user rapidly single-clicks the kitty 106 on the e-book's specific page, the control circuit 103 calculates the single-click gesture, the single-click force and the single-click position, and outputs the calculated results to the look-up table 104. The look-up table 104 judges that the user wants to pat the kitty 106 according to the received data, and drives the output circuit 105 to output the corresponding specific output data. For example, the output circuit 105 outputs the kitty's cry sound effect. In addition, when the user gently pats the kitty 106 on the specific page, the control circuit 103 calculates the dragging gesture, the dragging force and the dragging position, and outputs the calculated results to the look-up table 104. The look-up table 104 judges that the user wants to pat the kitty according to the received data, and drives the output circuit 105 to output the corresponding specific output data. For example, the output circuit 105 outputs the sound effect that the kitty feels comfortable or flighty.

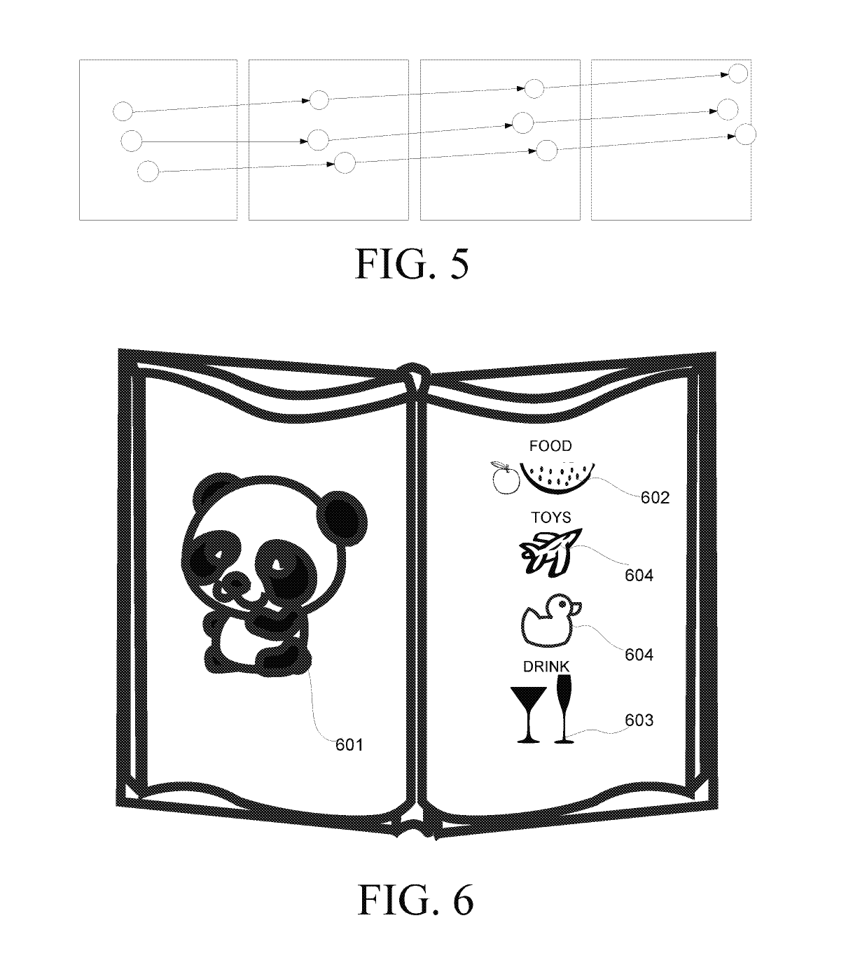

According to FIGS. 3A to 3C, it is obtained that the touch sensor 102 of the embodiment of the invention can perform the multi-touch sensing concurrently. That is, the touch sensor 102 calculates the change of the signal-to-noise ratio in the flat space of the specific page, for example, to obtain the change of the multi-point tracks, such as that shown in FIG. 5. FIG. 5 is a schematic view showing changes of the position and the sensing value when a dragging gesture is executed. Referring to FIG. 5, when the user performs the three-point dragging gesture concurrently, the touch sensor 102 detects the three-touch moving tracks in the sensed flat space. In addition, as shown in FIG. 5, the sensed three-touch moving tracks are not parallel moving tracks, and the moving tracks are detected and calculated to have the changes of different speeds and forces. In other words, this embodiment can detect the force representation of the multi-touch gesture, and judge the interactive feelings, actions and thinking contained in the user's touch behavior, so that the e-book has the more diversified interactive functions.

Next, the more diversified interactive applications according to this embodiment of the invention will be described with reference to another specific page. FIG. 6 is a schematic view showing a specific page according to another embodiment of the invention. Referring to FIG. 6, the specific page has specific virtual objects comprising a panda 601, a food 602, a drink 603 and a toy 604. In this embodiment, the user can similarly drag the food 602, drink 603 and toy 604 to the position of the panda 601 by touching the specific page to perform the interaction. Similarly, the user may also perform the interactive behavior with emotion (e.g., pat or gently pat the panda 601). In addition, according to the descriptions of FIGS. 5A to 5D, it is obtained that the touch sensor 102 of this embodiment can perform the multi-touch detection, so the user can concurrently drag two or more than two virtual objects (e.g., two toys 604) to the position of the panda 601 to perform the interaction. For example, when the touch sensor 102 and the control circuit 103 detect two dragging gestures and output the detected result to the look-up table 104, the look-up table 104 drives the output circuit 105 to output the corresponding specific output data (e.g., the happy sound effect) according to received detected information.

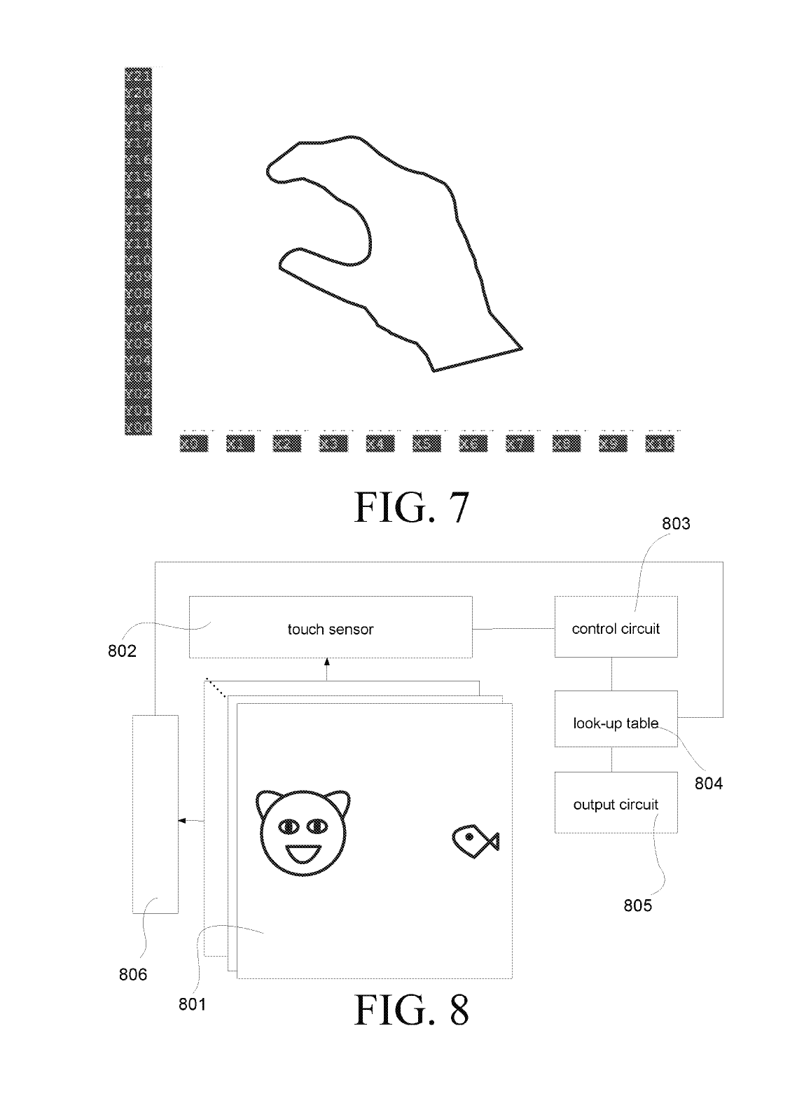

The touch sensor 102 and the control circuit 103 may further detect the hand gesture to recognize the user's hand gesture upon touching the specific page. FIG. 7 is a schematic view showing the hand gesture recognition according to an embodiment of the invention. When the user's hand gesture is that shown in FIG. 7, the touch sensor 102 and the control circuit 103 can recognize the hand gesture on the sensing plane. The hand gesture recognition may be applied to the specific page in FIG. 6, and work in conjunction with the above-mentioned force detection. When the user gently pats the panda 601 with the hand gesture of FIG. 7, the control circuit 103 judges the hand gesture, calculates the force and position of the hand gesture, and outputs the detected result to the look-up table 104. The look-up table 104 drives the output circuit 105 to output the corresponding specific output data (e.g., the special sound effect of being gently patted by the hand gesture) according to received detected information.

Although the invention is described with reference to the dragging of multiple virtual objects and the application of the hand gesture recognition, those skilled in the art should know that the touch sensor 102 with the multi-touch detection can perform more gesture detection comprising, for example, single clicking, double clicking, dragging, two-finger dragging, three-finger dragging, palm slapping, palm dragging or the like, and can be applied to the print article of the invention to execute the more diversified interactive functions. Thus, the invention is not restricted to the above-mentioned applications. In addition, the output circuit 105 is described with reference to only the speaker serving as an example. However, those skilled in the art should know that the interacting manners are not restricted to only the voice or sound transfer. For example, the output circuit 105 may also be a drive circuit for driving light-emitting diodes (LEDs), and controlling the lighting order of the LEDs to achieve the interacting effect. The output circuit 105 may also be, for example, a short-distance transmission module to be connected to another electronic device (tablet computer or smart mobile phone), and the interaction can be made through a display of the electronic device. Therefore, the output circuit of the invention is not restricted to the speaker. In addition, although the page of the e-book is in the form of a sheet, the page of the print article of the invention may also be made of a fabric material, a plastic material or the like. So, the invention does not intend to restrict the material of the page of the print article.

FIG. 8 is a system circuit diagram showing a print article with a multi-touch function according to a preferred embodiment of the invention. The multi-touch print article of this embodiment and that of the above-mentioned embodiment are the e-book having physical pages, for example. The e-book has pages 801, a touch sensor 802, a control circuit 803, a look-up table 804, an output circuit 805 and a page-turning detecting circuit 806. The page-turning detecting circuit 806 detects the page currently used by the user. The pages comprise a first detection page and a second detection page. The touch sensor 802 and the page-turning detecting circuit 806 are disposed on the first detection page and the second detection page, respectively. One of the first detection page and the second detection page may be, for example, a front cover, a back cover or a cover of the e-book. In the inner page of the e-book, the user can perform the multi-touch on at least two specific pages, wherein the specific page is the same as that of FIG. 1B, for example, and may also be the same as that of FIG. 6, for example. However, those skilled in the art should know that the specific page is only an example of interaction, and that the invention does not intend to restrict the interaction mode of the specific page.

In this embodiment, the operations of the touch sensor 802, the control circuit 803, the look-up table 804 and the output circuit 805 are similar to those of the touch sensor 102, the look-up table 104 and the output circuit 105 of FIG. 1B. The difference between this embodiment and the embodiment of FIG. 1B resides in that the look-up table 804 stores the specific output data corresponding to the positions of the virtual objects, the touch gestures and the touch forces on different specific pages. The page-turning detecting circuit 806 outputs the current page to the look-up table 804. When the touch sensor 802 detects the touch event, the look-up table 804 looks up the output data according to the current page detected by the page-turning detecting circuit 806, the touch gesture and the force, and the position information of the virtual object on the current page, and drives the output circuit 805 using the output data. The page-turning detecting circuit 806 of this embodiment pertains to the prior art, and may be implemented in various manners, such as optical detection, magnetic detection or the like. Thus, the detailed description of this embodiment will be omitted.

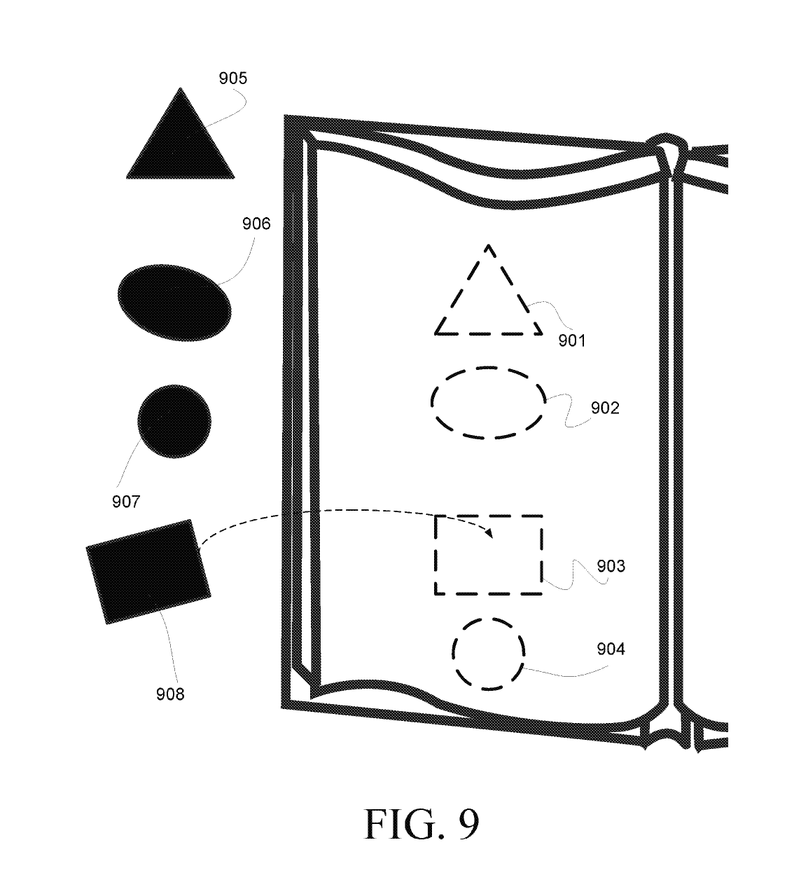

Next, the more diversified interactive applications according to this embodiment of the invention will be described with reference to another specific page serving as an example. The specific page may be applied to the e-book of FIG. 1B or 8. FIG. 9 is a schematic view showing a specific page according to another embodiment of the invention. Referring to reference FIG. 9, the specific page has outer profiles of multiple virtual objects. In this example, various shapes of outer profiles (901, 902, 903 and 904) are presented. In addition, the e-book of this embodiment also works in conjunction with multiple conductor objects (905, 906, 907 and 908) having the shapes corresponding to the outer profiles of the virtual objects, respectively. When the user places the conductor objects (905, 906, 907 and 908) on the specific page, the sensing plane of the touch sensor 102 detects the shapes and positions of the conductor objects, and outputs the detected data of the shapes and positions of the conductor objects to the look-up table 104. The look-up table 104 compares the received data with the data of the shapes and positions of the virtual objects to obtain compared results, and drives the output circuit 105 according to the compared results.

In this embodiment, the specific page and the conductor object serve as children's teaching toys, for example. When the user places the conductor object (905, 906, 907, 908) to the correct position of the virtual object (901, 902, 903, 904), the look-up table 104 drives the output circuit 105 to output the correct sound effect according to the detected result of the touch sensor 102 and the stored shape and position of the virtual object. On the contrary, if the user places the conductor object to the incorrect position, the look-up table 104 drives the output circuit 105 to output the error sound effect. The above-mentioned shapes and outer profiles are only examples of the e-book of the invention, and those skilled in the art should know that the e-book of the invention working in conjunction with the conductor objects can produce more interactive applications according to the understanding of this embodiment.

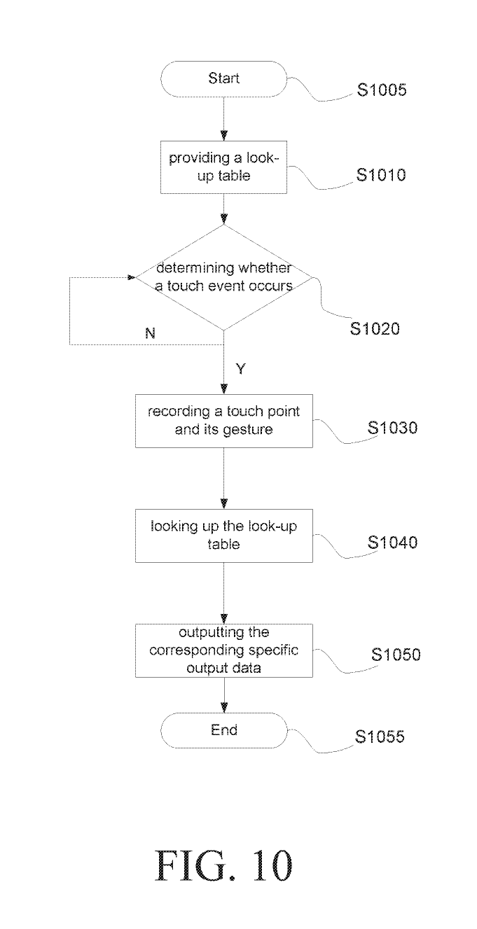

According to the embodiment of FIG. 1B, an interactive method can be summarized. FIG. 10 is a flowchart showing a interactive method for the print article with the multi-touch function according to an preferred embodiment of the present invention. Referring to FIG. 10, the interactive method comprises the steps as follow.

In step S1005, the interactive method starts.

In step S1010, a look-up table is provided, wherein the look-up table stores the a position of the specific virtual object and corresponding specific output data generated after the specific virtual object is touched.

In step S1020, it is determined whether a touch event occurs or not. When the sensing plane of the touch sensor 102 detects a touch event data, the step S1030 is performed.

In step S1030, a touch point and its gesture are recorded and the gesture and the touch event data are determined, wherein the touch event data may includes touch position, touch speed, the SNR of a touch point, touch pressure surface area and touch track.

In step S1040, a corresponding specific output data is found by looking up the look-up table according to the touch point(s) and the gesture(s) thereof.

In step S1050, the corresponding specific output data is output to the output circuit such that the output circuit is driven to output corresponding interaction.

In step S1055, the interactive method ends.

In summary, the spirit of the invention is to utilize the touch sensor with the high signal-to-noise ratio to achieve the determination of the touch behaviors of the user's gesture, force, speed and the like, and thus to respond with the interactive reaction corresponding to the corresponding behavior. Thus, the independent conventional click-event reaction is no longer present on the same coordinate, while the interactive behaviors with the richer behavior modes are present. Thus, more interactive applications are provided on the print article with the multi-touch function. For example, the conceptions including the printed electronic pet and the like may also have their values in these applications.

While the present invention has been described by way of examples and in terms of preferred embodiments, it is to be understood that the present invention is not limited thereto. To the contrary, it is intended to cover various modifications. Therefore, the scope of the appended claims should be accorded the broadest interpretation so as to encompass all such modifications.

What is claimed is:

1. A print article with a multi-touch function, the print article comprising:
a specific page, having at least one specific virtual object;
a touch sensor;
a look-up table, coupled to the touch sensor, wherein the look-up table stores the a position of the specific virtual object and corresponding specific output data generated after the specific virtual object is touched; and
an output circuit, which is coupled to the look-up table and receives the output data;
wherein when the print article with the multi-touch function is turned to the specific page, the touch sensor detects a touch event on the specific page and the touch event is directed to a gesture of the virtual object on the specific page, the look-up table outputs the corresponding specific output data to the output circuit according to the gesture and the specific virtual object.

2. The print article according to claim 1, wherein:
when the print article with the multi-touch function is turned to the specific page, and the touch sensor detects the touch event on the specific page, the look-up table outputs the corresponding specific output data to the output circuit according to the gesture, touch event data, the specific virtual object and the specific page,
wherein the look-up table further stores corresponding relationships between the specific page and the gesture, the touch event data and the output data.

3. The print article according to claim 2, wherein the touch event data is selected from the group consisting of a touch position, a touch speed, a signal-to-noise ratio of a touch point, a touch pressure surface area and a touch track.

4. The print article according to claim 2, wherein the touch sensor comprises a sensing plane for sensing touched coordinates, wherein when the touch event occurs, the touch sensor detects the touched coordinates and the signal-to-noise ratios thereof within every predetermined period of time, and the specific output data corresponding to the gesture and the touch event data is found by looking up the look-up table.

5. The print article according to claim 4, further comprising:
a control circuit, for recording the touched coordinates and the signal-to-noise ratios thereof within every predetermined period of time, and calculating the touch event data.

6. The print article according to claim 1, further comprising:
a plurality of pages, comprising a first sensing page and a second sensing page and the specific page, wherein the touch sensor is disposed on the first sensing page; and
a page-turning detecting circuit, which is disposed on the second sensing page, and for detecting a current page of the print article,
wherein when the page-turning detecting circuit detects that the print article is turned to the specific page, the touch sensor detects that the touch event is present on the specific page, and the touch event is directed to the gesture of the virtual object on the specific page, the look-up table outputs the corresponding specific output data to the output circuit according to the gesture, the specific virtual object and the specific page.

7. The print article according to claim 6, wherein the first sensing page and the second sensing page are covers of the print article.

8. The print article according to claim 1, wherein the specific page comprises a first virtual object, a second virtual object and a third virtual object, wherein the gesture comprises sliding to the first virtual object after the second virtual object and the third virtual object are touched concurrently.

9. A interactive method, adapted for a print article with a multi-touch function, wherein the print article comprises a specific page, a touch sensor and an output circuit, wherein the specific page has at least one specific virtual object, wherein the interactive method comprises:
providing a look-up table, wherein the look-up table stores the a position of the specific virtual object and corresponding specific output data generated after the specific virtual object is touched;
determining whether a touch event occurs or not;
recording a touch point and its gesture when the touch event occurs;
looking up the look-up table according to the touch point and its gesture to find a corresponding specific output data; and
output the corresponding specific output data to the output circuit.

10. The interactive method according to claim 9, further comprising:
when the print article with the multi-touch function is turned to the specific page, the touch sensor detects a touch event on the specific page, looking up the look-up table according to the gesture, a touch event data, the specific object and the specific page, to find corresponding output data to output to the output circuit,
wherein the look-up table further stores the touch event data on the specific page and corresponding output data.

11. The interactive method according to claim 10, wherein the touch event data is selected from the group consist of a touch position, a touch speed, a signal-to-noise ratio of a touch point, a touch pressure surface area and a touch track.

12. The interactive method according to claim 10, wherein the touch sensor comprises a sensing plane for sensing touched coordinates, wherein when the touch event occurs, the interactive method further comprising:
detecting the touched coordinates and the signal-to-noise ratios thereof within every predetermined period of time;
recording the touched coordinates and the signal-to-noise ratios thereof;
transferring the touched coordinates and the signal-to-noise ratios thereof into the gesture and the touch event data; and
finding the specific output data corresponding to the gesture and the touch event data by looking up the look-up table.

13. The interactive method according to claim 9, wherein the print article further comprises a plurality of pages and a page-turning detecting circuit, wherein the interactive method further comprises:
providing the look-up table, wherein the look-up table stores the positions of virtual objects of the pages and corresponding output data after the virtual objects are touched;
detecting a current page of the print article;
finding the position of the virtual object of the current page according to the current page;
determining whether a touch event occurs;
recording a touch point and its gesture when the touch event occurs;
looking up the look-up table according to the current page, the touch point and its gesture to find the corresponding specific output data; and
output the corresponding specific output data to the output circuit.

14. A print article with a multi-touch function, the print article comprising:
a specific page, disposed on an outer profile of at least one virtual object;
a conductor object, having a shape corresponding to the outer profile of the virtual object;
a touch sensor;
a look-up table, coupled to the touch sensor, wherein the look-up table stores a position of the virtual object and corresponding specific output data generated after the virtual object is touched;
an output circuit, which is coupled to the look-up table and receives the output data;
wherein when the print article is turned to the specific page, and the touch sensor detects a touch event on the specific page, and the touch event is triggered by the conductor object, the look-up table outputs the corresponding specific output data to the output circuit according to the shape and the position of the conductor object and the virtual object.

15. The print article according to claim 14, wherein when the print article is turned to the specific page, and the touch sensor detects the touch event on the specific page, and the touch event is triggered by the conductor object, the look-up table judges whether the shape and the position of the conductor object coincide with the virtual object, and outputs the corresponding specific output data according to a judged result.

16. The print article according to claim 14, further comprising:
a plurality of pages, comprising a first sensing page and a second sensing page and the specific page, wherein the touch sensor is disposed on the first sensing page; and
a page-turning detecting circuit, which is disposed on the second sensing page, and for detecting a current page of the print article,
wherein when the page-turning detecting circuit detects that the print article is turned to the specific page, the touch sensor detects that the touch event is present on the specific page, and the touch event is directed to the gesture of the virtual object on the specific page, the look-up table outputs the corresponding specific output data to the output circuit according to the gesture, the specific virtual object and the specific page.

17. The print article according to claim 16, wherein the first sensing page and the second sensing page are covers of the print article.
